(19) United States
(12) Patent Application Publication
(10) Pub. No.: US 2013/0254703 A1
(43) Pub. Date: Sep. 26, 2013

(54) MEDICAL INFORMATION SYSTEM RULESET CREATION AND/OR EVALUATION GRAPHICAL USER INTERFACE

(71) Applicants: Robert Stanley Arling, North Andover, MA (US); Joseph Ernest Rock, Littleton, MA (US)

(72) Inventors: Robert Stanley Arling, North Andover, MA (US); Joseph Ernest Rock, Littleton, MA (US)

(21) Appl. No.: 13/990,831

(22) PCT Filed: Nov. 25, 2011
(86) PCT No.: PCT/IB11/55302

§ 371 Date: May 31, 2013

Related U.S. Application Data
(60) Provisional application No. 61/419,417, filed on Dec. 3, 2010.

(51) Int. Cl. G06F 3/0484

(52) U.S. Cl. CPC G06F 3/0484
USPC 715/781

(57) ABSTRACT

A method includes presenting, via a display, an interactive graphical user interface, wherein the interactive graphical user interface presents one or more rule set creation windows that display user selected content that formalizes relationship between logical reporting elements for a medical study of interest. A system includes a storage medium including a clinical decision support application and a processor that executes the clinical decision support application, wherein the executed clinical decision support application presents an interactive graphical user interface for creating a rule set that formalizes a relationship between logical reporting elements for a medical study of interest based on user input. A computer readable storage medium encoded with computer executable instructions, which, when executed by a processor of a computer, cause the processor to: generate based on user input a clinical decision support rule set that formalizes relationships between logical reporting elements for a medical study of interest.

The following generally relates to medical information systems and more particularly to an interactive clinical decision support (CDS) system ruleset creation and/or evaluation graphical user interface (GUI). The following is also amenable to non-medical information systems.

A clinical decision support (CDS) system generally is a computing system that executes a software application that facilitates decision-making by a clinician in the clinical setting. Typical modern day CDS systems execute user interactive software applications that assist clinicians with pre-diagnoses, diagnoses and/or post diagnoses decisions, and facilitate clinicians with creating medical reports.

For a typical imaging study, the reading physician makes use of various anatomic measurement values derived from images in the study. These values, as well as the reader's conclusions embodied in “findings” and other reporting data elements, are used to document the results of the imaging study in a medical report. Findings are typically constrained to be selected from a certain set which is standard to an institution, but free-form text findings have also been used. The resulting report can be stored electronically, printed, etc.

Unfortunately, the assignment of findings in a report is susceptible to human error. While some of these errors are inevitable, others are due to causes that are detectable and correctable. For example, the simultaneous use of findings which are inconsistent (e.g. “The left ventricle is normal” and “The left ventricle is severely enlarged”) is obviously incorrect and easily detectable. More advanced relationships between the logical elements of a report (e.g. between measurement values and findings) can be used to either point out potential inconsistencies in the report or suggest findings that may be missing.

Although there is a desire in the medical community to standardize medical findings among different institutions, this has not yet occurred, and, given the non-standard nature of the findings used in modern day medical reports, it is difficult to develop CDS system algorithms to detect various inconsistencies in a report.

Aspects of the present application address the above-referenced matters, and others.

According to one aspect, a method includes presenting, via a display, an interactive graphical user interface, wherein the interactive graphical user interface presents one or more ruleset creation windows that display user selected content that formalizes relationship between logical reporting elements for a medical study of interest.

According to another aspect, a system includes a storage medium including a clinical decision support application and a processor that executes the clinical decision support application, wherein the executed clinical decision support application presents an interactive graphical user interface for creating a ruleset that formalizes a relationship between logical reporting elements for a medical study of interest based on user input.

According to another aspect, a computer readable storage medium encoded with instructions which, when executed by a processor of a computer, cause the processor to: generate based on user input a clinical decision support ruleset that formalizes relationships between logical reporting elements for a medical study of interest.

The invention may take form in various components and arrangements of components, and in various steps and arrangements of steps. The drawings are only for purposes of illustrating the preferred embodiments and are not to be construed as limiting the invention.

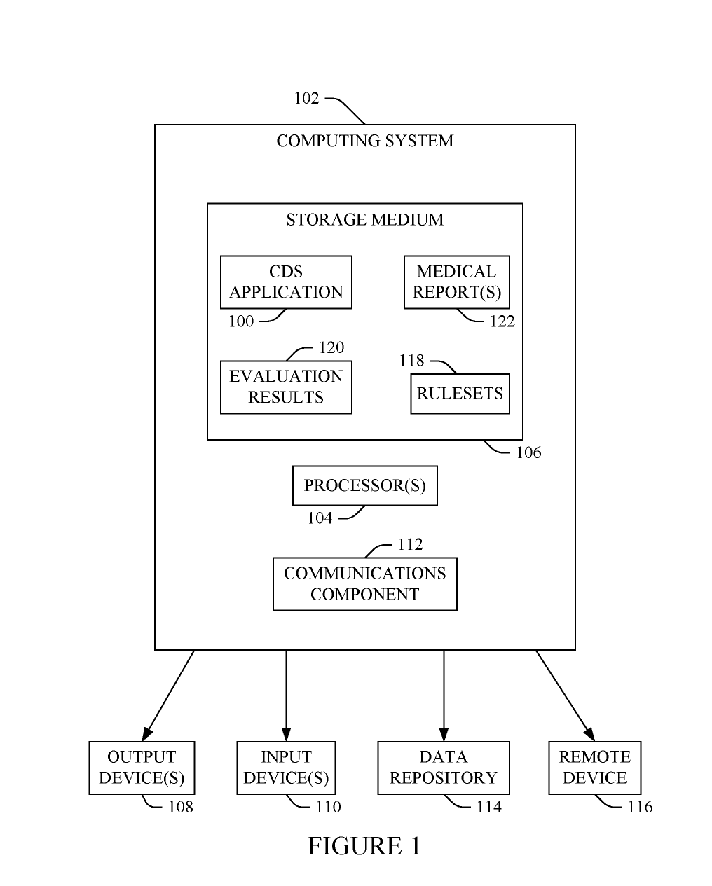

FIG. 1 illustrates an example computing system that executes a clinical decision support application.

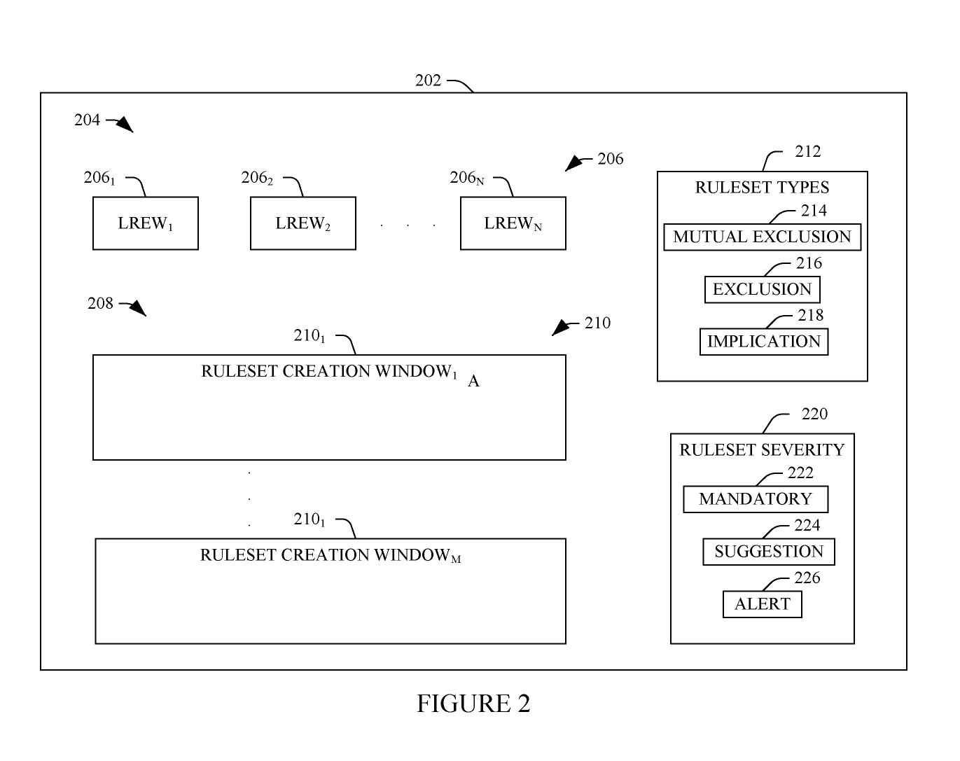

FIG. 2 illustrates an example graphical user interface for creating clinical decision support rulesets.

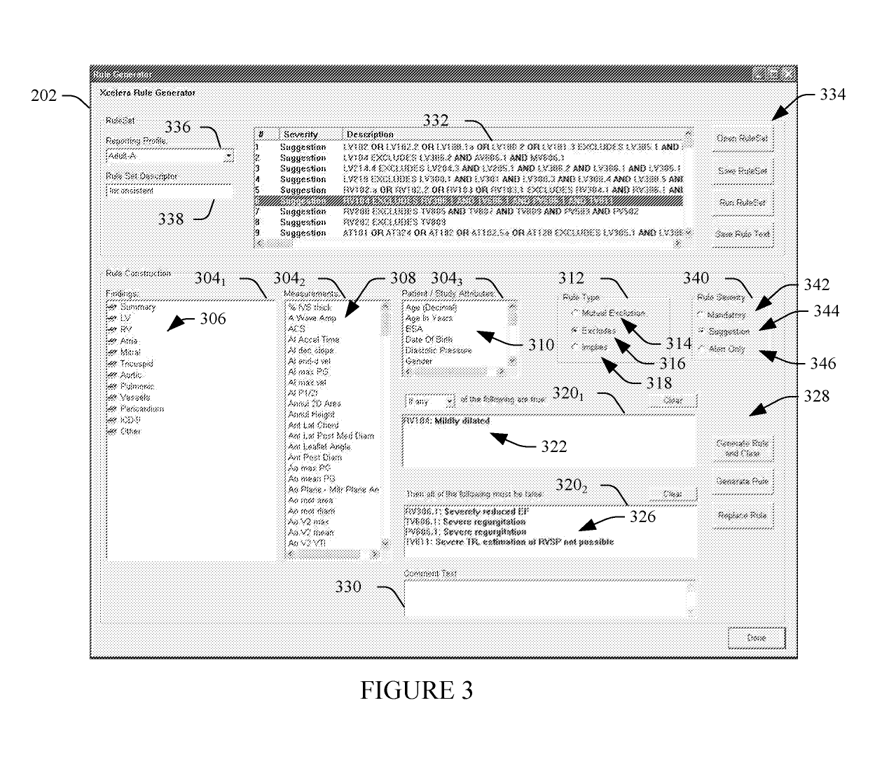

FIG. 3 illustrates an example graphical user interface for creating rulesets in connection with an ultrasound imaging application.

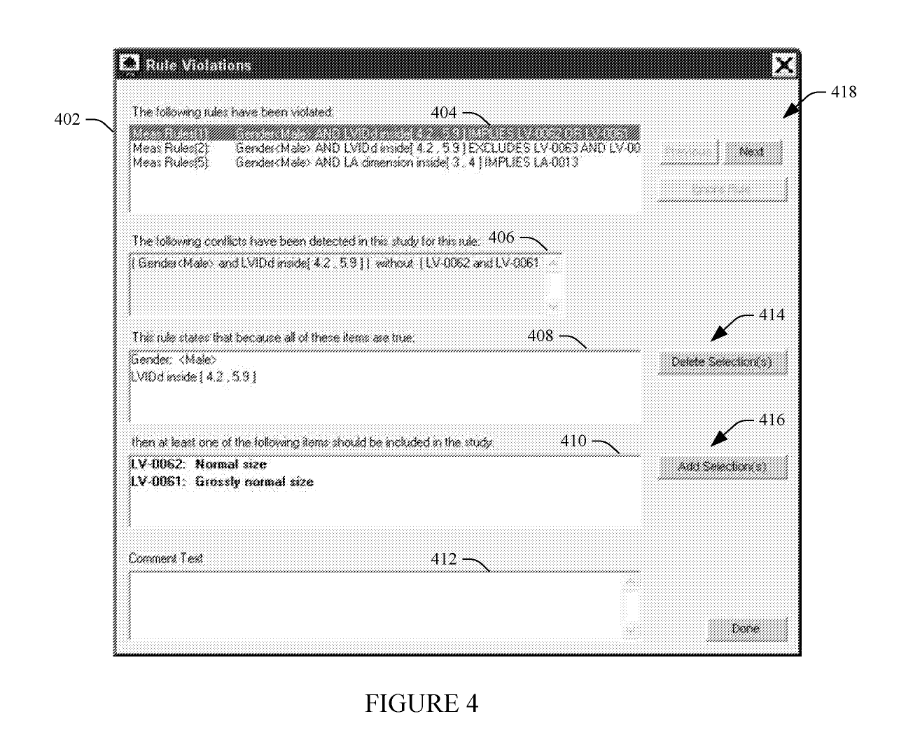

FIG. 4 illustrates an example graphical user interface for prospectively evaluating a ruleset that includes an implication ruleset.

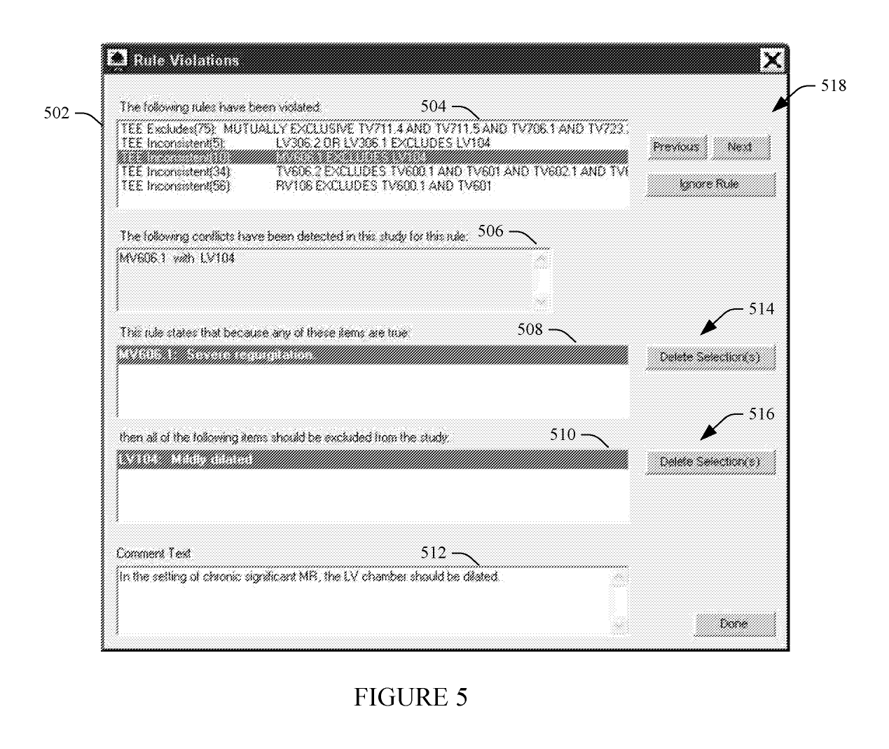

FIG. 5 illustrates an example graphical user interface for prospectively evaluating a ruleset including an exclusion ruleset.

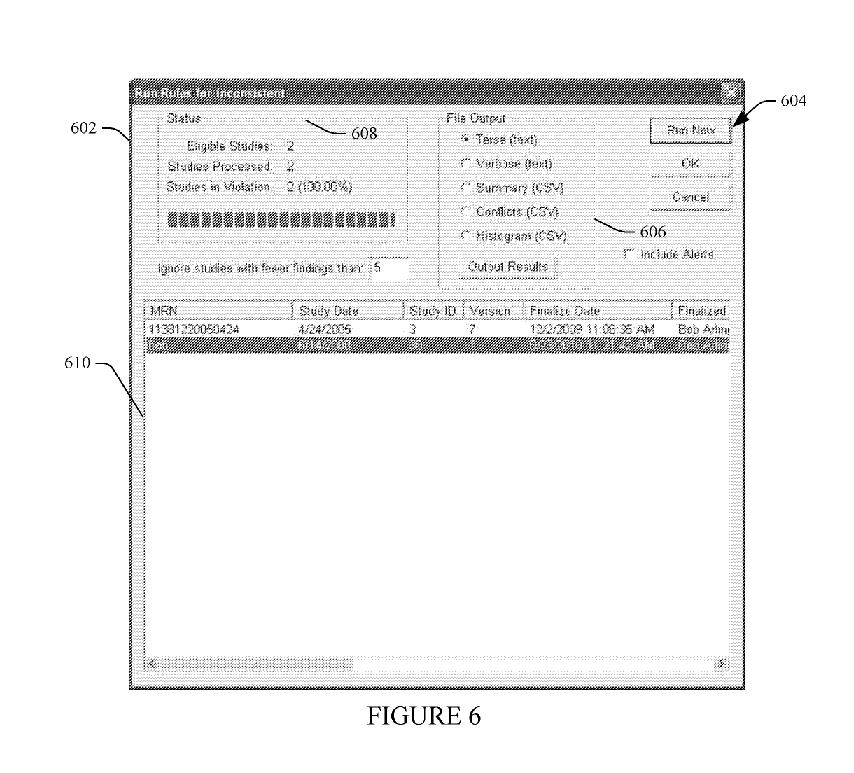

FIG. 6 illustrates an example graphical user interface for retrospectively evaluating a ruleset based on a previously generated medical report.

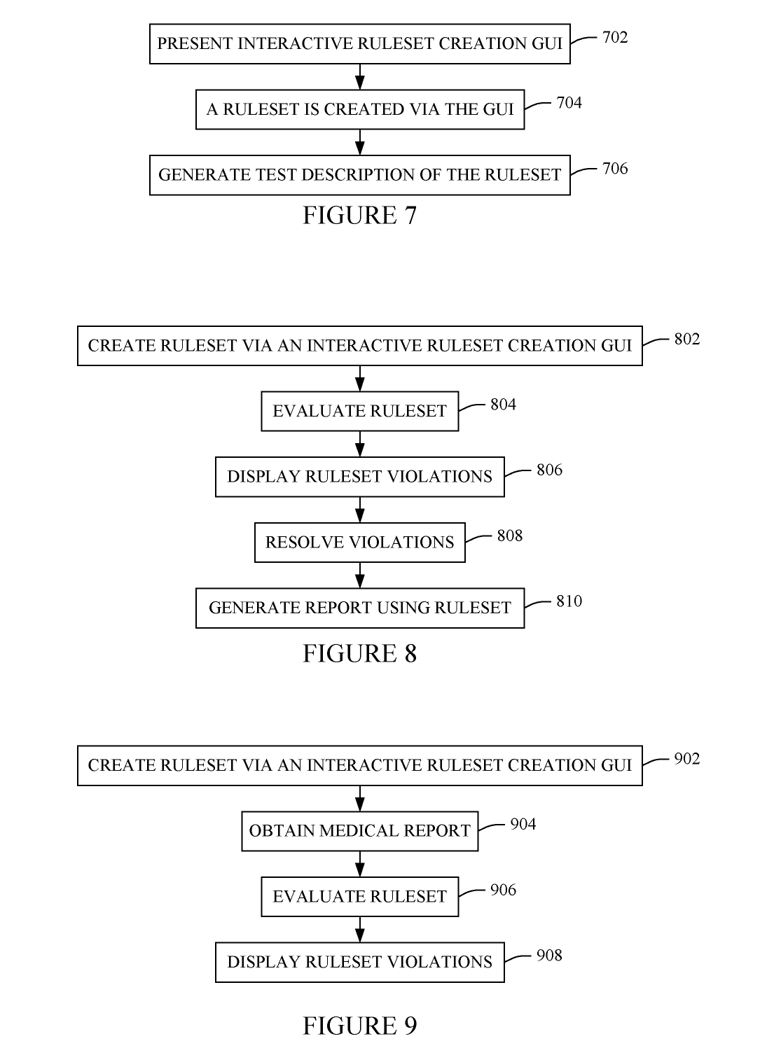

FIG. 7 illustrates a method for creating a ruleset in connection with a clinical decision support application.

FIG. 8 illustrates a method for prospectively evaluating a ruleset in connection with generating a medical report.

FIG. 9 illustrates a method for retrospectively evaluating a ruleset based on previous generated medial reports.

FIG. 1 illustrates an example computing system 102 such as a workstation, a computer, or the like. The computing system 102 includes one or more processor 104 and computer readable storage medium 106 (physical memory) encoded or embedded with computer readable instructions, which, when executed by the one or more processors 104 cause the system 102 to carry out various functionality. The computing system 102 also includes one or more output device 108 such as a display, a printer, etc. that can be used to visually present and/or provide information.

The computing system 102 further includes one or more input device 110 such as a keyboard, a keypad, a mouse, a trackball, a digital pen, a microphone, or the like allow a user to interact with the computing system 102. The computing system 102 also includes a communications component 112, which allows the system 102 to communicate with one or more data repositories 114, such as a picture archiving and communication system (PACS), a radiology information system (RIS), a hospital information system (HIS), a databases, a server, a computer and/or other repository, and one or more remote devices 116 such as another computing system, a computer, and/or other remote device.

In the illustrated embodiment, the storage medium 106 at least includes instructions corresponding to a rule-based clinical decision support (CDS) application 100, which, when executed by a processor(s) 104, cause the computer system 102 to run a CDS application that employs and presents one or more graphical user interfaces (GUI). The executing CDS application facilitates users with creating medical reports based on findings, measurements, and/or other reporting elements.

A suitable GUI presents information in one or more windows. As utilized herein, a window is a visualization area or region of the GUI that presents (or visually outputs) information and/or accepts input or information. One or more windows can be superimposed over, graphically placed behind, and/or move around (e.g., via mouse or the like) in connection with one or more other windows. Such windows may be independent or dependent upon another window.

As described in greater detail below, in one instance, one or more GUIs present an interactive tool that facilitates creating and/or evaluating one or more rules used for generating medical reports. As utilized herein, a rule consists of one or two clauses, a clause includes one or more propositions combined using logical operators (e.g., AND, OR, NOT, MUTUAL EXCLUSION, etc.), and a proposition is an atomic logical statement that evaluates to true or false. A collection of rules forms a ruleset 118, which formalize one or more relationships between logical reporting elements, such as medical findings, measurement values, patient demographics (attributes), and/or other reporting elements. The rulesets 118 can be stored in the storage medium 106 (as shown), a data repository 114, and/or other storage medium. In one embodiment, a GUI allows for evaluating one or more rulesets 118, for example, to check for inconsistencies and/or contradictory logical reporting elements in medical reports 122 utilizing a prospective and/or retrospective approach.

With a proactive approach, one or more rulesets 118 may be evaluated while a medical report 122 is being created, and evaluation results 120 may guide the user by illuminating inconsistent and/or potentially missing report elements. With a retroactive approach, one or more rulesets 118 may be evaluated using previously created medical reports 122, for example, to gather information on the accuracy of those reports and/or gain insight as to the validity of one or more rulesets 118. The evaluation results 120 and/or the medical reports 122 can be stored in the storage medium 106 (as shown), a data repository 114, and/or other storage medium. The above may facilitate improving overall accuracy and ultimately patient outcomes.

One or more such GUIs can be used for a teaching, research, diagnosis and/or other tool. For teaching, the evaluation of rules during the creation of a medical report can serve as a valuable teaching tool for clinicians new to the field or new to a given site. For research, a retrospective evaluation of complex rulesets can be used in a data-mining capacity to search for complex relationships among the reporting data elements for research purposes. For diagnosis, the GUI can be used to develop very sophisticated and tailored rules that attempt to diagnose disease states and/or suggest the appropriate findings for a certain patient, clinician, and/or institution, for example, to enhance consistent usage.

Rulesets in the storage medium 106, the data repository 114, and/or elsewhere can be shared and/or utilized by one or more other computing systems and/or other systems.

FIG. 2 illustrates an example GUI 202 that allows a user to create and/or edit one or more rulesets.

The illustrated GUI 202 includes a logical reporting region 204 with one or more logical reporting element windows (LREW) 206₁, 206₂, . . . , 206_{N} (where N is an integer equal to or greater than one), each presenting a set of logical reporting elements. The logical reporting element windows 206₁, 206₂, . . . , 206_{N} are collectively referred to herein as logical reporting elements windows 206. Examples of suitable logical reporting elements include, but are not limited to, medical findings, measurement values, patient demographics (attributes) and/or other reporting elements.

The illustrated GUI 202 also includes a rules creation region 208 that includes one or more ruleset creation windows 210₁, . . . , 210_{M} (where M is an integer equal to or greater than one), collectively referred to herein as rule creation windows 210. Logical reporting elements presented via the logical reporting elements windows 206 can be used to populate the windows 210 to create rulesets. In one instance, logical reporting elements are dragged from the windows 206 and dropped in the one or more rule creation windows 210 via a mouse or the like.

A ruleset type window 212 presents one or more user selectable ruleset type. Examples of ruleset types include, but are not limited to, mutual exclusion 214, exclusion 216, implication 218, and/or other ruleset types. An example mutual exclusion ruleset type indicates that the ruleset can only include a single clause, an example exclusion reset type indicates that if the first clause evaluates to true, then the second clauses must be false, and an example implication reset type indicates that if the first clause evaluates to true, then the second clause must be true. A clause consists of one or more logical statements that evaluate to true or false.

A ruleset severity window 220 presents one or more severity options. Examples of severity options include, but are not limited to, mandatory 222, suggestion 224, alert only 226, and/or other severity options. A mandatory severity level indicates that if the ruleset fails verification, then the resulting violations in the medical report must be corrected before the medical report is finalized if being evaluated in a prospective manner (i.e., the ruleset is always enforced). A suggestion severity level indicates that the user may override an indication that the ruleset failed verification and/or accept a suggestion predicted to correct the ruleset (i.e., the ruleset may be expressly ignored). An alert only severity level indicates that a notification indicating a ruleset failed verification is merely presented (i.e., the user is simply made aware of the failure).

It is to be appreciated that in another embodiment one of more of the illustrated windows may be omitted or presented in another GUI. In addition, one or more other windows may be presented in the GUI 202.

FIG. 3 provides an example of the GUI 202 in connection with an ultrasound (US) application. It is to be understood that this example is not limiting and the GUI can be utilized with other imaging (e.g., US, CT, PET, SPECT, MRI, and/or other imaging modalities) and/or non-imaging applications.

A logical reporting element window 304₁ includes multiple findings propositions 306, including left ventricle (LV), right ventricle (RV), atria, mitral valve, tricuspid, aortic, pulmonic, vessel, pericardium, ICD-9, and other findings. In the illustrated embodiment, a finding proposition 306 includes a logical statement indicating that a specific finding should be either present in or absent from the report.

A finding may be simple factual statement (e.g. “A large basal aneurysm is present.”) or a more complicated statement such as a multiple choice finding that allows the user to select one from a set of choices (e.g. “The left ventricle is (slightly, moderately, severely) dilated”). For these more complex findings, the finding proposition could evaluate to true if the multiple-choice finding exists in the report only with a specific value filled in, or, alternately, it could evaluate to true if the finding exists in the report with any of the choices filled in.

A logical reporting element window 304₂ includes multiple measurement propositions 308. In the illustrated embodiment, a measurement proposition 308 includes a logical statement dealing with a specific anatomic measurement that evaluates to true or false. One example might be “LVIDd <3.0 cm.” Along with simple numeric comparisons (<, <=, >, >=, =, not =), additional examples of measurement propositions involve stating the measurement value is inside/outside a specific range and stating the measurement value is present/absent in the report.

A logical reporting element window 304₃ includes patient/study demographic or attribute propositions 310 such as age, date of birth, blood pressure, etc. attributes. In the illustrated embodiment, a demographic proposition 310 includes a logical statement dealing with a specific patient demographic found in the report (e.g. patient age, gender, etc.) that evaluates to true or false. Similar to the findings and measurement propositions, this statement might involve numeric values (e.g. patient age >20) or specific choices for the parameters involved (e.g. gender=male).

It is to be appreciated that one of more of the findings 306, one or more of the measurements 308, and/or one or more of the attributes 310 can be a default or a customized (e.g., via clinician, facility, etc.).

A ruleset type window 312 includes an exclusion ruleset type 314 (which is selected in this example), a mutual exclusion ruleset type 316, and an implication ruleset type 318. Based on the exclusion ruleset type 314 selection, a ruleset creation window 320₁ includes one or more clauses (e.g., single clause 322 in the illustrated window 320₁). A drop-down box 323 specifies whether at least one (“any”) or all of the propositions included in Window 320₁ need to be true in order to trigger the rule. A ruleset creation window 320₂ includes clauses 326 corresponding to findings that must be false based on the clause 320. In the illustrated embodiment, soft buttons 328 are provided for generating, clearing, and/or replacing entries, and a window 330 is provided for adding comments, etc.

The GUI 202 also includes a summary window 332 that lists the created ruleset. Highlighting or otherwise selecting a particular one of the rules automatically populates the other windows with information corresponding to the selected one of the rules. Various soft buttons 334 allows for opening, saving, and running rulesets, and saving rulesets as text files (e.g., for printing, sharing, etc.), and windows 336 and 338 allow for naming ruleset reporting profiles and presenting ruleset descriptors.

A rule severity window 340 includes mandatory 342, suggestion 344 (selected) and alert only 346 severity level options. As described herein, the severity level may be used to determine a different behavior while evaluating rules, allowing the user to override certain rules while others are always enforced. This capability might also take into account the experience of the user through use of a role-based scheme or other mechanism.

FIG. 4 illustrates a GUI 402 that presents results for one or more prospectively evaluated rulesets for an implication rule type.

A window 404 presents user selectable evaluated rules that failed evaluation. In the illustrated embodiment, the window 404 presents identification indicia corresponding to the violated ruleset and rule within the ruleset. The illustrated selected (via highlighting) rule in the window 404 is an implication rule, as shown via the presented identification indicia (“IMPLIES”).

A window 406 presents one or more identified conflicts for the evaluated ruleset that is selected in the window 404. In this example, the presented conflict indicates that findings, measurements and attributes (“LVID,” “inside[4.2, 5.9],” and “male”) are selected without certain implied findings (“LV-0062” and “LC-0061”). Windows 408 and 410 present the rule selected in the window 404. The window 408 presents the findings, measurements and attributes present in the current medical report, and the window 410 presents the implied findings for this rule.

A window 412 displays comments which were entered to explain the rule currently selected in window 404.

Soft buttons 414 and 416 respectively allow the user delete one or more of the selected findings, measurements and attributes, or add one or more of the unselected implied findings in an attempt to resolve the conflict. Once a finding is deleted, the rulesets are again checked for violations.

Other soft buttons 418 allow the user to move back and forward through violations and/or ignore certain rules, such as rules identified as ignorable like rules that are not designated as mandatory. In this example, the violation cannot be ignored.

A log can be maintained that records whenever a medical report is modified in response to rule violations. For example, if the user were to add a finding based on the rule violation displayed this event would be logged. The log can later be examined to determine how effective the rules are at catching errors, the percent of time medical reports are modified in response to rule violations, etc. This in turn could enable development of more effective rulesets.

Similar to the other GUIs described herein, the content of the GUI 402 is provided for explanatory purposes and is not limiting.

FIG. 5 illustrates a GUI 502 that presents results for one or more prospectively evaluated rulesets for an exclusion rule type.

A window 504 presents user selectable evaluated rules that failed evaluation. In the illustrated embodiment, the window 504 presents identification indicia corresponding to the violated ruleset and rule within the ruleset. The illustrated selected (via highlighting) rule in the window 504 is an exclusion rule, as shown via the presented identification indicia (“EXCLUDES”).

A window 506 presents one or more identified conflicts for the evaluated rule that is selected in the window 504. In this example, the presented conflict indicates that certain multiple findings are concurrently selected (“MV606.1 with LV104”). Windows 508 and 510 present the ruleset selected in the window 504. The window 508 presents the first finding (“MV606.1”), and the window 510 presents the finding (“LV104”) that is excluded for this rule.

A window 512 displays comments which were entered to explain the rule in window 504.

Soft buttons 514 and 516 respectively allow the user delete one or more of the selected findings in an attempt to resolve the conflict. Once a finding is deleted, the rulesets are again checked for violations.

Other soft buttons 518 allow the user to move back and forward through violations and/or ignore certain rules, such as rules identified as ignorable like rules that are not designated as mandatory. In this example, the violation can be ignored.

Similar to the other GUIs described herein, the content of the GUI 502 is provided for explanatory purposes and is not limiting.

This prospective rule evaluation GUIs 402 and/or 502 can be utilized as a guide for a user to create a more accurate medical report. This can be done, for example, when a medical report is about to be finalized, or on demand. The illustrated GUIs not only display which rulesets have been violated, but also suggest a solution (e.g. add/remove a specific finding) and, if possible, allow the user to easily perform the suggested solution in a way to minimize disruption of workflow.

FIG. 6 illustrates a GUI 602 that presents results for one or more retrospectively evaluated rulesets.

Soft button 604 allows the user to invoke retrospective evaluation. A file output option region 606 allows the user to select one or more file output types for the evaluation results and invoke file output according to the selected type(s). An evaluation status region 608 shows various information such as a number of studies eligible for evaluation, a number of studies evaluated, and a number of evaluated studies in violation. In other embodiment, similar or different, including more or less information can be presented in the region 608. A results window 610 presents information about any studies that resulted in one or more violations during ruleset evaluation. Selecting a particular study may invoke instantiation of another window with further information about the specific ruleset violations discovered for that study.

Available rulesets can be evaluated for each relevant study in the database and statistics gathered as to how many and which rules were violated, as well as any other pertinent information stored in the database (e.g. who created the report, etc.) Reports of this information in various printed and graphical format can be produced. This information can be useful for determining the overall accuracy of the medical reports in the database with the goal of improving said accuracy through training, new protocols and procedures, and/or developing rulesets with the correct degree of rigor. Having this capability available in an interactive manner during ruleset development allows for more efficient design of robust rulesets which minimize alarm fatigue, etc.

Similar to the other GUIs described herein, the content of the GUI 602 is provided for explanatory purposes and is not limiting.

Below are several non-limiting examples of other suitable other functionality that can be included in one or more of the GUIs described herein and/or other GUI.

An alert ruleset may include a rule type which raises an alert (utilizing a text message or other means) to the user when violated, but does not suggest other modification of the report data. An alert facility might also be incorporated with the rule types above and might function as a mechanism to further explain the logic behind unusually complicated rules while the user is creating the medical report, thus functioning as a type of electronic help system.

A normative data ruleset may include a set of implication rules which pre-seed the medical report with the appropriate findings based upon measurement values found in the report. These rules would be executed at once to initially populate a report, and after which point the user could interactively remove any of those findings which were not pertinent.

A alert content ruleset may state that the elements in its single component clause should exist in the report. For example the patient date of birth or certain measurements may need to be in each report according to the protocol of the institution.

A multiple modality ruleset includes rules that can be used in multiple imaging and/or non-imaging modalities. For example, there may be rules developed which take data elements from multiple medical reports from different sources and infer conclusions from the aggregate data.

Other rulesets are also contemplated herein.

It is also to be appreciated that machine learning can be used to facilitate generating rules. By way of example, instead of using static rules, the rules themselves can be created and/or modified through use of various artificial intelligence techniques, creating an adaptive system that “learns” with the passage of time. As a simple example, examination of inter-finding correlations in a medical database may be used to develop rules that suggest certain findings given the presence of others already in the report, based on the statistical probability at a given site.

Suitable rules also include rules that take into account past data as well as data from the current study. An example of this might be a rule which compares the change over time (i.e. trend) of a specific measurement value with a known threshold. Similarly, rules could be constructed involving progression of disease states or pathology (as described by findings in the relevant reports) over time.

FIG. 7 illustrates method for creating a ruleset.

At 702, an interactive ruleset creation GUI is presented in connection with an executing CDS application.

At 704, the GUI is utilized to create and save a ruleset that formalize relationship between logical reporting elements, such as medical findings, measurement values, patient demographics (attributes), and/or other reporting elements.

At 706, a text description of the ruleset may be produced. In another embodiment, act 706 is omitted.

FIG. 8 illustrates method for prospectively evaluating a ruleset.

At 802, a user interacts with an interactive ruleset creation GUI to create a ruleset for a study of interest.

At 804, the ruleset is evaluated based on a currently opened study, which, in this example, is the study of interest.

At 806, a GUI showing any ruleset violations is displayed.

At 808, the violations are resolved via the GUI and the ruleset is saved.

At 810, a medical report is generated for the study of interest based on the ruleset.

FIG. 9 illustrates method for retrospectively evaluating a ruleset.

At 902, a user interacts with an interactive ruleset creation GUI to create a ruleset.

At 904, the user obtains a previously created medical report from a database or the like (e.g., one of the data repositories 104 of FIG. 1).

At 906, the ruleset is evaluated based on the medical report.

At 908, a GUI showing any ruleset violations is displayed.

It is to be appreciated that the ordering of the acts in the methods described herein is not limiting. As such, other orderings are contemplated herein. In addition, one or more acts may be omitted and/or one or more additional acts may be included.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method, comprising:
presenting, via a display, an interactive graphical user interface, wherein the interactive graphical user interface presents one or more ruleset creation windows that display user selected content that formalizes relationship between logical reporting elements for a medical study of interest, the logical reporting elements including at least one of a medical finding, a measurement value, or a patient demographic in a medical report, and wherein a first of the ruleset creation windows presents a user selected physiological state for a patient corresponding to the medical study and another of the ruleset creation windows presents one of a related, an excluded, an implied or an alternative physiological state of the patient based on the physiological state presented in the first of the ruleset creation windows.

2. The method of claim 1, wherein the interactive graphical user interface is presented in connection with an executing clinical decision support system.

3. (canceled)

4. (canceled)

5. (canceled)

6. (canceled)

7. (canceled)

8. The method of claim 1, further comprising:
evaluating the ruleset prospectively based on the medical study.

9. The method of claim 8, further comprising:
presenting a graphical user interface that presents any violations of the ruleset identified by evaluating the ruleset prospectively based on the medical study.

10. The method of claim 9, further comprising:
ignoring the violation.

11. The method of claim 9, wherein the graphical user interface presents at least one suggestion for resolving a violation, and further comprising:
utilizing the graphical user interface to resolve the presented violation based on the at least one suggestion.

12. The method of claim 11, wherein the violation has to be resolved in order to save and utilize the ruleset.

13. The method of claim 11, further comprising:
resolving the violation includes at least one of adding or deleting an entry suggested by the ruleset.

14. The method of claim 1, further comprising:
evaluating the ruleset retrospectively based on a previously generated medical report.

15. The method of claim 14, further comprising:
presenting a graphical user interface that presents any violations of the ruleset identified by evaluating the ruleset retrospectively.

16. The method of claim 1, wherein the ruleset is utilized with one or more different medical modalities to respectively generate one or more corresponding medical reports.

17. A system, comprising:
a storage medium including an application; and
a processor that executes the application, wherein the executed application presents an interactive graphical user interface for creating a ruleset that formalizes a relationship between logical reporting elements for a medical study of interest based on user input, the logical reporting elements including at least one of a medical finding, a measurement value or a patient demographic in a medical report, and wherein a first of the ruleset creation windows presents a user selected physiological state for a patient corresponding to the medical study and another of the ruleset create windows present one of a related, an excluded, an implied or an alternative physiological state of the patient based on the physiological state presented in the first of the ruleset creation windows.

18. (canceled)

19. (canceled)

20. (canceled)

21. (canceled)
